(19) United States
(12) Patent Application Publication
(10) Pub. No.: US 2021/0354959 A1
(43) Pub. Date: Nov. 18, 2021

(54) CONSTRUCTION METHOD OF THE GRIPPING EQUIPMENT OF A LIFTING APPARATUS AND LIFTING APPARATUS PROVIDED WITH SUCH GRIPPING EQUIPMENT

(71) Applicant: FAMATEC S.R.L., PREDAIA (TN) (IT)

(72) Inventor: Fabrizio ZAMBELLI, PREDAIA (TN) (IT)

(21) Appl. No.: 17/318,226

(22) Filed: May 12, 2021

(30) Foreign Application Priority Data
May 15, 2020 (IT) 102020000011206

(51) Int. Cl. B66C 1/02; B66C 23/00

(52) U.S. Cl. CPC B66C 1/0243; B66C 23/005; B66C 1/0212

(57) ABSTRACT

Gripping equipment for lifting apparatuses of the type comprising: a rigid support framework which is adapted to be fixed/attached to the lifting apparatus; and one or more manually controlled gripping members that are firmly fixed to said rigid support framework, and are adapted to grasp and hold a specific object to be moved; said rigid support framework comprising at least one rectilinear tubular element with polygonal cross-section, which is made of metal and has a sectional modular structure.

### CROSS-REFERENCE TO RELATED APPLICATIONS

This Patent application claims priority from Italian Patent Application No. 102020000011206 filed on May 15, 2020, the entire disclosure of which is incorporated herein by reference.

### TECHNICAL FIELD

The present invention relates to a construction method of the gripping equipment of a lifting apparatus and to a manually operated lifting apparatus provided with such gripping equipment.

More in detail, the present invention relates to a construction method of the gripping equipment of a pneumatic manipulator and to a pneumatic manipulator provided with such gripping equipment, to which the following description will explicitly refer without thereby losing generality.

### BACKGROUND ART

As is known, pneumatic manipulators are weight-compensation lifting apparatuses that generally comprise: a supporting column firmly fixed to the ground in a generally vertical position; a movable beam which extends more or less parallel to the ground, and is butt fixed on the top of the supporting column with the capability of freely rotating with respect to the latter about a vertical rotation axis, so as to be able to swing over a substantially horizontal plane; a movable arm which extends in cantilever manner from the distal end of the movable beam, and is butt fixed onto the distal end of the movable beam, with the capability of freely rotating with respect to the latter around two independent rotation axes, one vertical and the other horizontal; and a gripping equipment which is fixed to the distal end of the movable arm with the capability of freely rotating around a vertical rotation axis, and is structured so as to selectively grasp and firmly hold a specific object.

More in detail, the gripping equipment is firmly fixed to the distal end of the movable arm of the manipulator, so as to remain suspended beneath the distal end of the movable arm.

Finally, the pneumatic manipulator is moreover provided with an electro-pneumatic weight-balancing device, which is capable of varying on command the inclination of the movable arm with respect to the vertical, and of continuously compensating the weight of the movable arm, of the gripping equipment and of the object held by the gripping equipment, so that the operator can lift and freely move the object in the space with a minimum physical effort, while manually giving the gripping equipment or directly the object integral therewith a light push.

The gripping equipment, in turn, is generally made up of a series of manually-controlled gripping members that are firmly fixed to a rigid support framework which, in turn, is firmly fixed to the distal end of the movable arm so as to remain suspended beneath the movable arm.

Clearly, the structure of the gripping equipment varies depending on the type of object to be grasped, thus the shape of the rigid support framework, the type of gripping member to be used, and the arrangement of the gripping member(s) on the rigid framework are established each time based on the specifications of the client.

Since the rigid support framework of the gripping equipment has to be made ad hoc for a specific object to be grasped and moved, it is currently formed by a series of rectilinear metallic section-bars with square cross-section, generally butt welded to one another.

Clearly, a rigid support framework manufactured in such manner has relatively high production costs, because the cut to size and the welding of the various metallic section-bars are relatively laborious and expensive operations.

Additionally, the assembling of the rigid support framework requires the immediate availability of an appropriate number of rectilinear metallic section-bars of different sizes, with the supplying problems and with the storage costs that this entails.

### DISCLOSURE OF INVENTION

Aim of the present invention is to reduce the production costs of the rigid support framework of the gripping equipment of the pneumatic manipulators.

In compliance with these aims, according to the present invention there is provided a gripping equipment for lifting apparatuses as defined in claim 1 and preferably, though not necessarily, in any one of the claims dependent thereon.

According to the present invention there is also provided a construction method of the gripping equipment of a lifting apparatus as defined in claim 13 and preferably, though not necessarily, in any one of the claims dependent thereon.

Finally, according to the present invention there is also provided a lifting apparatus as defined in claim 18 and preferably, though not necessarily, in any one of the claims dependent thereon.

### BRIEF DESCRIPTION OF THE DRAWINGS

The present invention will now be described with reference to the accompanying drawings, which illustrate a non-limiting embodiment example thereof, wherein:

FIG. 1 is a perspective view of a lifting apparatus provided with a gripping equipment realized according to the teachings of the present invention, with parts removed for clarity's sake;

FIG. 2 is a perspective view of the gripping equipment shown in FIG. 1, with parts removed for clarity's sake;

FIG. 3 is a partially exploded perspective view of the gripping equipment illustrated in FIGS. 1 and 2, with parts removed for clarity's sake;

FIG. 4 is a perspective view of a tubular element with square cross-section of the gripping equipment shown in the previous figures, with parts in cross-section and parts removed for clarity's sake;

Figures from 5 to 8 schematically illustrate some steps of the construction of the tubular element with square cross-section illustrated in FIGS. 2, 3 and 4; whereas

FIG. 9 is a perspective view of a variant of the gripping equipment shown in FIGS. 1, 2 and 3.

### BEST MODE FOR CARRYING OUT THE INVENTION

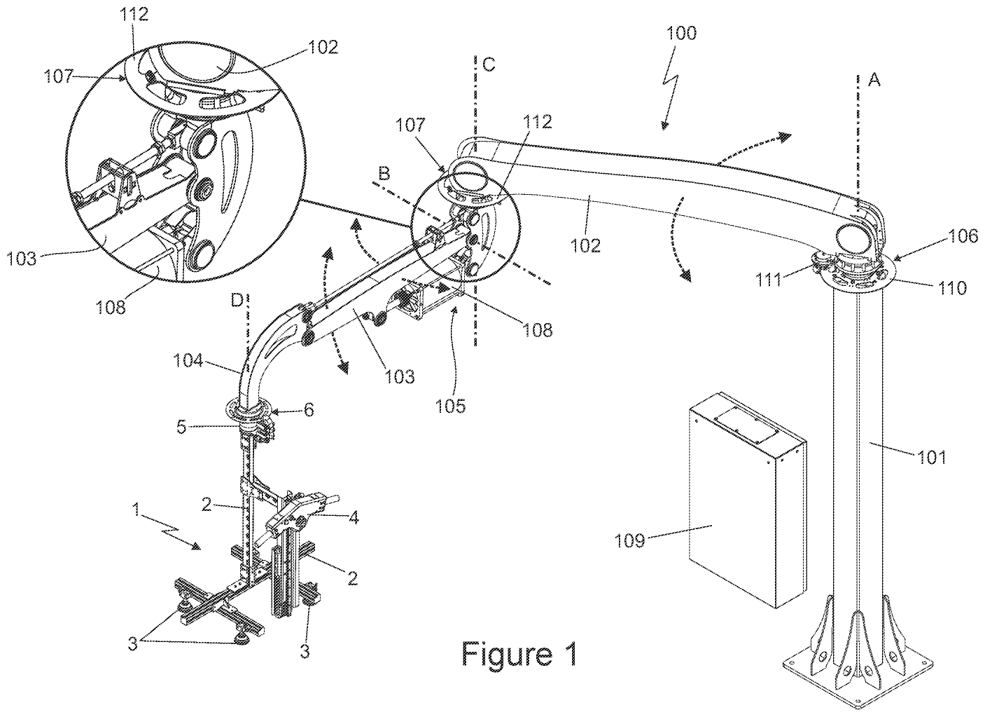

With reference to FIGS. 1, 2 and 3, number 1 denotes, as a whole, a gripping equipment which is structured so as to be selectively grasp and firmly hold a specific object generally of great weight, and which is particularly suitable to be mounted on a lifting and assisted-movement apparatus of pieces preferably of the weight-compensation type.

In other words, the gripping equipment 1 is particularly suitable to be mounted on a manually-operated lifting apparatus 100, which is capable of continuously compensating/balancing the weight of the gripping equipment 1 and of the object temporarily integral therewith, so as to allow a person to lift and freely move such object in the space with a minimum physical effort, preferably manually giving the gripping equipment 1 or the object a direct light push.

Preferably, the lifting apparatus 100 is additionally a pneumatic manipulator or similar.

With reference to FIG. 1, in particular the lifting apparatus 100 preferably comprises: a supporting column 101 which is firmly fixed to the ground in a substantially vertical position; a movable beam 102 which extends more or less parallel to the ground, and is butt fixed on the top of the supporting column 101 with the capability of freely rotating with respect to the latter about a rotation axis A preferably substantially vertical, so as to be able to swing over a preferably substantially horizontal plane; and a movable arm 103 which extends in cantilever manner from the distal end of the movable beam 102, and is butt fixed onto the distal end of the movable beam 102 with the capability of freely rotating with respect to the latter about a rotation axis B preferably substantially horizontal and/or substantially perpendicular to axis A, so as to be able to swing over a preferably substantially vertical plane.

Preferably, the movable arm 103 is moreover fixed to the distal end of the movable beam 102 also with the capability of freely rotating with respect to the latter about a second rotation axis C preferably substantially vertical and/or anyway locally substantially perpendicular to axis B, so as to be able to swing over also a second plane preferably substantially horizontal.

The gripping equipment 1 is preferably firmly fixed/coupled to the distal end of the movable arm 103 so as to be directly supported by the movable arm 103.

More in detail, the gripping equipment 1 is preferably firmly fixed to the distal end of the movable arm 103, so as to remain suspended beneath the distal end of the movable arm 103.

Preferably, the gripping equipment 1 is furthermore fixed to the distal end of the movable arm 103 in a rigid, though easily removable manner.

More in detail, with reference to FIG. 1, in the example shown, the movable arm 103 preferably has an articulated parallelogram geometry, and is preferably provided, at its distal end, with a curved terminal 104 which extends downwards and is adapted to directly support the gripping equipment 1.

In other words, the gripping equipment 1 is preferably fixed firmly and in removable manner to the curved terminal 104.

With reference to FIG. 1, the lifting apparatus 100, or rather the pneumatic manipulator, additionally comprises also a weight-balancing device 105, which is capable of continuously compensating the weight of the movable arm 103, of the gripping equipment 1 and of the object temporarily integral therewith, so as to allow a person to manually move in the space, with a minimum/negligible physical effort, the object temporarily integral with the gripping equipment 1.

More in detail, the weight-balancing device 105 is preferably adapted to vary on command the inclination of the movable arm 103 with respect to the vertical, and to continuously compensate the weight of the movable arm 103, of the gripping equipment 1 and of the object temporarily integral therewith, so that any possible further movement in space of the gripping equipment 1 and/or of the object temporarily integral therewith can be manually executed by the operator with a minimum physical effort, preferably acting directly on the gripping equipment 1 and/or on the object temporarily integral therewith.

Preferably, the lifting apparatus 100, or rather the pneumatic manipulator, is moreover also provided with a first blocking device 106 which, on command, is capable of blocking/preventing rotation of the movable beam 102 on the top of supporting column 101, around the axis A; and/or with a second blocking device 107 which, on command, is capable of blocking/preventing rotation of the movable arm 103 on the distal end of movable beam 102, around the axis C.

With reference to FIG. 1, in particular, the weight-balancing device 105 is preferably electro-pneumatically operated, and preferably comprises: at least a pneumatic cylinder 108 with single or double effect, which is interposed between the movable arm 103 and the distal end of the movable beam 102, and adapted to vary in real time the inclination of the movable arm 103 with respect to the vertical; and an electropneumatic air-supply assembly 109, which is adapted to adjust the flow of pressurized air from and to the pneumatic cylinder 108, so as to control the inclination of the movable arm 103 with respect to the vertical and to continuously compensate the weight of the gripping equipment 1 and of its load, i.e. the object temporarily integral therewith.

More in detail, the electropneumatic air-supply assembly 109 is capable of adjusting the flow of pressurized air to and from the pneumatic cylinder 108 preferably so as to be able, in sequence: to lower the movable arm 103 so as to bring the gripping equipment 1 close to or in contact with the object to be picked up and moved; optionally to raise the movable arm 103 so as to bring the gripping equipment 1 and its load, i.e. the object to be moved integral therewith, at a given height from the ground; and then compensate the weight of the gripping equipment 1 and of its load, i.e. of the object to be moved, so that the further movements in space of the gripping equipment 1 and of its load can be manually operated by the operator, acting directly on the gripping equipment 1 with a minimum physical effort.

In the example shown, in particular, the blocking devices 106 and/or 107 are preferably electro-pneumatically operated, and are optionally supplied by the same pressurized-air source that supplies also the electropneumatic air-supply assembly 109 of the weight-balancing device 105.

More in detail, the blocking device 106 is preferably an electro-pneumatically operated disc-caliper braking assembly.

In other words, the blocking device 106 preferably comprises: a disc 110 of metallic material, which is rigidly fixed on the top of the supporting column 101, substantially coaxial to axis A; a pneumatically-operated caliper 111, which is integral with the movable beam 102, is slidingly fitted onto the disc 110, and is finally adapted to pinch, on command, the body of disc 110 so as to prevent any movement between the two elements; and a preferably electrically-operated control valve (not shown in the figures), which is adapted to control/adjust the flow of pressurized air to the caliper 111.

Likewise, the blocking device 107 is preferably an electro-pneumatically operated disc-caliper braking assembly.

In other words, the blocking device 107 preferably comprises: a disc 112 of metallic material, which is rigidly fixed to the distal end of movable beam 102 substantially coaxial to axis C; a pneumatically-operated caliper (not shown in the figures), which is integral with the movable arm 103, is slidingly fitted on the disc 112, and is finally adapted to pinch, on command, the body of disc 112 so as to prevent any movement between the two elements; and a preferably electrically-operated control valve (not shown in the figures), which is adapted to control/adjust the flow of pressurized air to the caliper 112.

With reference to FIGS. 1, 2 and 3, the gripping equipment 1 on the other hand comprises: a rigid support framework 2 adapted to be fixed/attached to the lifting apparatus 100; and one or more manually-controlled gripping members 3 that are firmly fixed to the rigid framework 2, and are adapted to selectively grasp and stably hold the object to be moved.

More in detail, the rigid support framework 2 is preferably adapted to be fixed/attached to the distal end of movable arm 103, or rather to the curved terminal 104, so as to remain suspended beneath the movable arm 103. Preferably, the rigid support framework 2 is moreover adapted to be fixed onto the distal end of the movable arm 103 in a rigid, though easily removable manner.

Additionally, the gripping equipment 1 preferably also comprises a manually-operated control unit 4 which is adapted to command the gripping member(s) 3, and is preferably fixed/attached to the rigid framework 2 in a position easily reachable by the operator.

Preferably, the control unit 4 of the gripping equipment 1 is furthermore adapted to command also the electropneumatic air-supply assembly 109 of the weight-balancing device 105 and/or the blocking devices 106 and/or 107.

More in detail, the control unit 4 is preferably adapted to open and close, on command, the control valves of the blocking devices 106 and/or 107.

Clearly the structure of the gripping equipment 1 varies depending on the type of object to be grasped.

In other words, the shape/structure of the rigid support framework 2 and the type and position of the gripping member(s) 3 to be used vary depending on the type of object to be grasped.

With reference to FIGS. 1, 2 and 3, preferably the gripping equipment 1 moreover includes also a rotating joint 5 which is interposed between the rigid framework 2 and the distal end of the movable arm 103, or rather the curved terminal 104, and allows the rigid framework 2 to freely rotate with respect to the movable arm 103 about a preferably substantially vertical, rotation axis D.

Preferably, the gripping equipment 1 additionally includes also a blocking device 6 that is preferably placed at the rotating joint 5, and is capable of blocking/preventing, on command, the rotation of the rigid support framework 2 on the distal end of the movable arm 103, about axis D. The control unit 4 of the gripping equipment 1, in addition, is preferably adapted to command also the blocking device 6.

More in detail, also the blocking device 6 is preferably operated electro-pneumatically, and is optionally supplied by the same pressurized air source that supplies also the electropneumatic air-supply assembly 109 of the weight-balancing device 105 and/or the blocking devices 106 and/or 107.

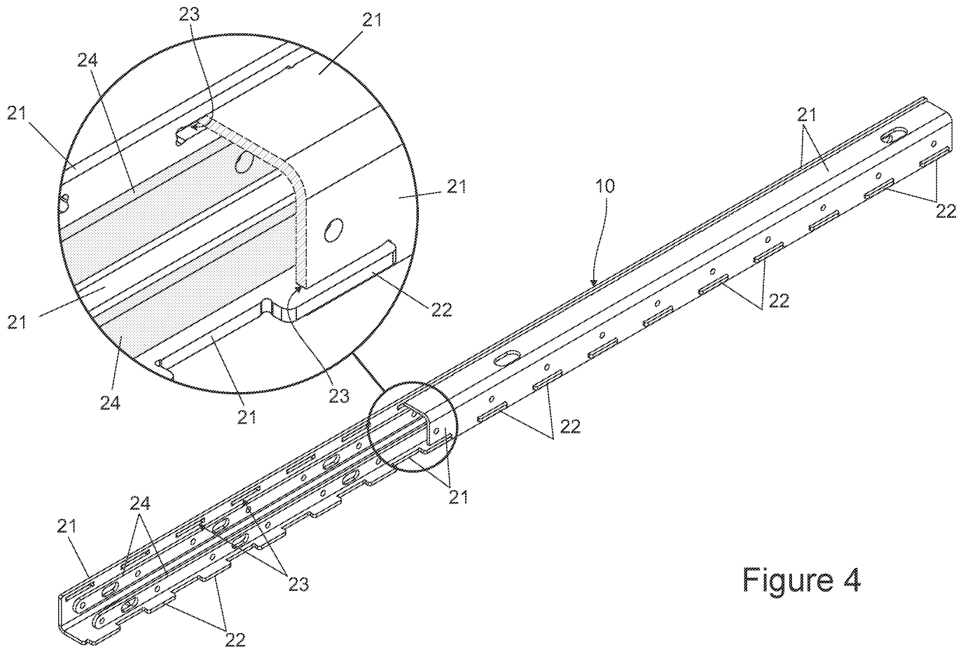

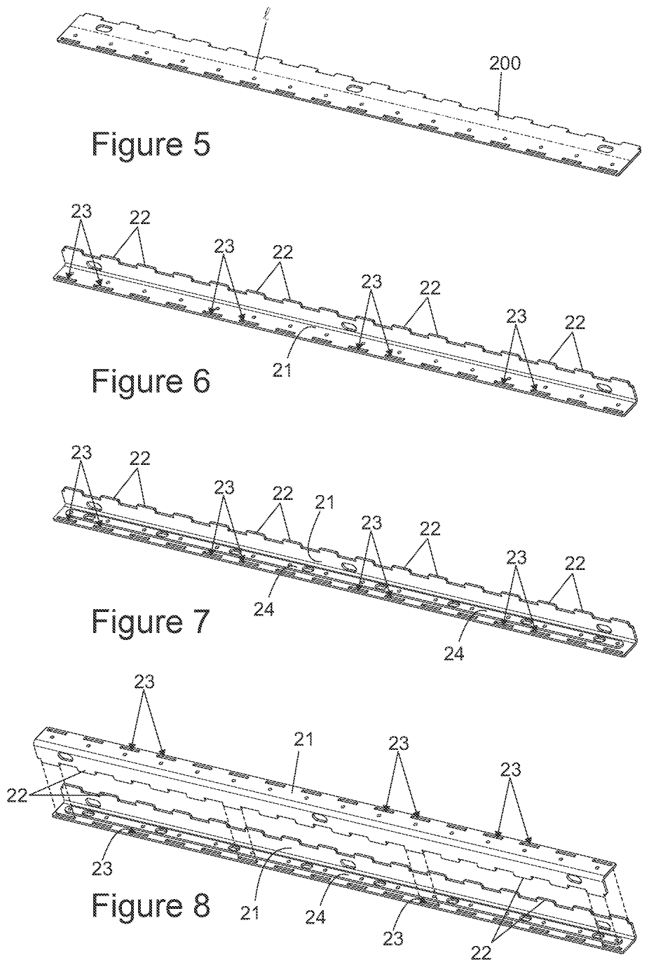

With reference to FIG. 4, in particular, the rotating joint 5 is preferably divided into an upper rotating section and into a lower rotating section, which are capable of freely rotating with respect to one another about the axis D. The upper rotating section is adapted to be firmly fixed to the distal end of the movable arm 103. The lower rotating section, on the other hand, is adapted to be firmly fixed to the rigid framework 2.

The blocking device 6, in turn, is preferably an electro-pneumatically operated disc-caliper braking assembly.

In other words, the blocking device 6 preferably comprises: a disc 7 of metallic material, which is rigidly fixed to the upper rotating section of rotating joint 5, so as to be substantially coaxial to the rotation axis D of the joint and integral with the distal end of the movable arm 103; a pneumatically-operated caliper 8, which is integral with the lower rotating section of rotating joint 5, is slidingly fitted on the disc 7, and is finally adapted to pinch, on command, the body of disc 7 so as to prevent any movement between the two rotating sections of rotating joint 5; and a preferably electrically-operated control valve (not shown in the figures), which is adapted to control/adjust the flow of pressurized air to the caliper 8.

Clearly, the control unit 4 is preferably adapted to open and close, on command, also the control valve of the blocking device 6.

With reference to FIGS. 1, 2 and 3, in turn the rigid support framework 2 of gripping equipment 1 comprises: at least one rectilinear tubular element, rigid and with polygonal cross-section, which is made of metal and has a sectional modular structure; and optionally also one or more metal bars, preferably rectilinear and preferably with a monolithic structure, which are rigidly fixed to one another and/or to said rectilinear tubular element so as to form a self-supporting rigid structure.

More in detail, said at least one rectilinear tubular element preferably has a cross-section with an equilateral convex polygon shape (i.e. with all the sides equal to one another) and/or an equiangular shape (i.e. with all the angles equal to one another).

More conveniently, said at least one rectilinear tubular element is preferably with roughly-squared cross-section, i.e. with a substantially rectangular or square cross-section.

Additionally, said at least one rectilinear tubular element is basically made up of two rectilinear metallic section-bars of given length and with a preferably L- or C-shaped cross-section, separate and distinct from one another, which are arranged adjacent to one another and are shaped so as to be able to firmly fit one into the other along the respective longer longitudinal edges, so as to form a rigid tubular structure with polygonal cross-section which substantially copies the shape of said rectilinear tubular element.

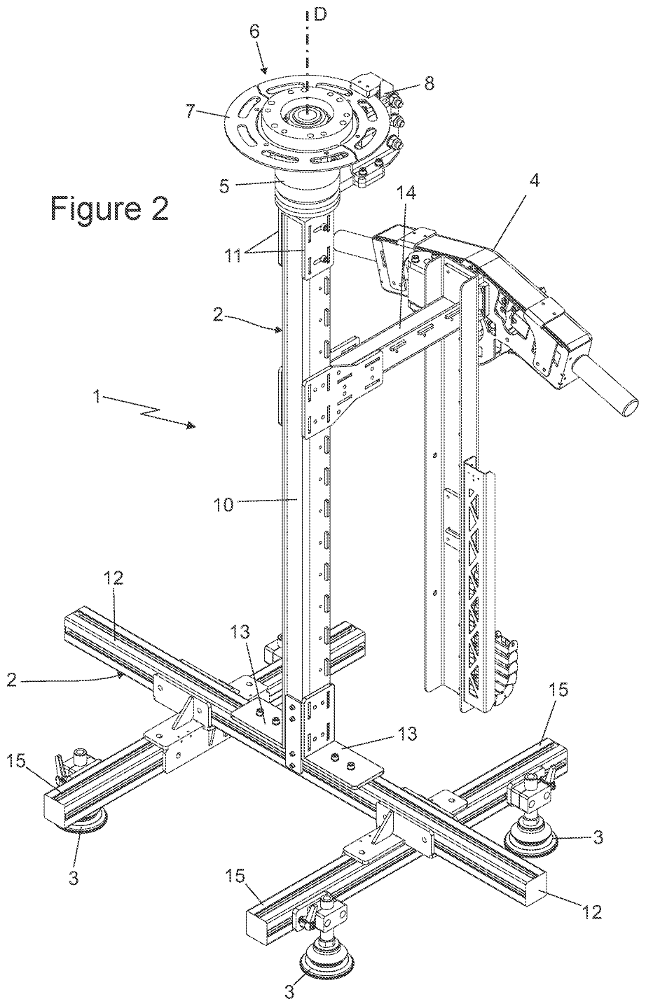

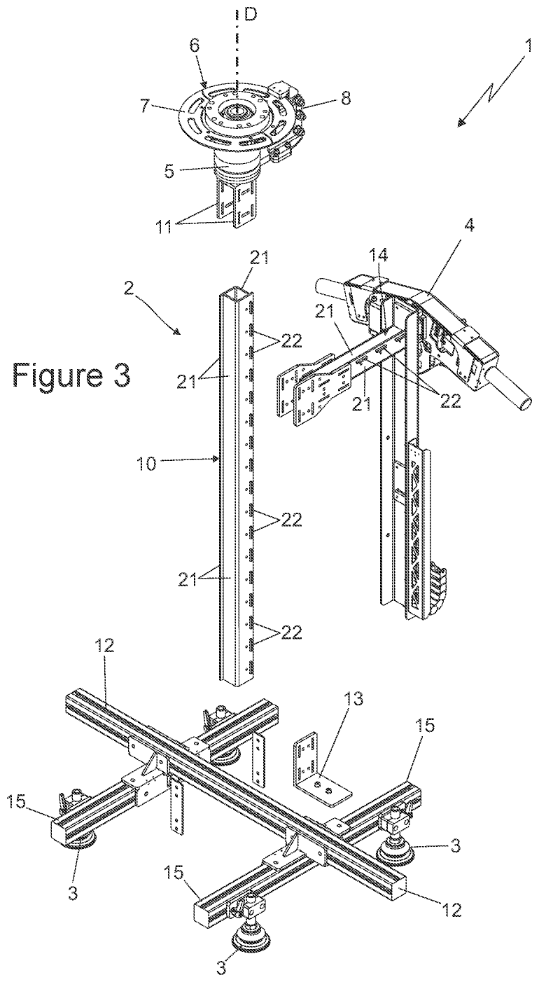

With reference to FIGS. 2 and 3, in the example shown, in particular, the rigid support framework 2 preferably comprises: a first rectilinear tubular element 10 with polygonal cross-section, and more conveniently with a roughly-square cross-section, which is arranged in a substantially vertical position, beneath the rotating joint 5, preferably so as to be locally substantially coaxial or anyway parallel to the axis D, and has the upper end rigidly fixed to the rotating joint 5, or rather to the lower rotating section of rotating joint 5, preferably by means of a pair of plate-shaped connection brackets 11; and a first metallic transversal bar 12 preferably monolithic and/or rectilinear, which is rigidly fixed to the lower end of the rectilinear tubular element 10, i.e. on the opposite side with respect to the rotating joint 5, preferably by means of a second pair of plate-shaped connection brackets 13, so as to form a rigid structure shaped substantially like an inverted T.

Preferably, the rigid support framework 2 furthermore comprises: a second rectilinear tubular element 14 with a polygonal cross-section, and more conveniently with a roughly-squared cross-section, which is arranged in a substantially horizontal position, beside to the rectilinear tubular element 10, and is rigidly butt fixed to the side of the rectilinear tubular element 10 preferably by means of a third pair of plate-shaped connection brackets, so as to protrude cantilevered from the latter orthogonally to the longitudinal axis of the rectilinear tubular element 10 and/or to the lying plane of the rigid structure having a substantially inverted T-shape; and two further metallic transversal bars 15 preferably substantially rectilinear and/or monolithic, which are arranged in a substantially horizontal position, beneath the metallic transversal bar 12, are perpendicular to the metallic transversal bar 12, and are finally rigidly fixed to the metallic transversal bar 12 preferably in a substantially specular position on opposite sides the centerline of the metallic transversal bar 12.

The gripping members 3 are preferably firmly fixed to the metallic transversal bars 15.

More in detail, in the example shown, the gripping members 3 preferably include one or more suction cups which are fixed cantilevered beneath the metallic transversal bars 15 preferably in a manually adjustable manner, and are for example capable of holding a glass sheet or marble slab.

In other words, in the example shown, the gripping equipment 1 is preferably structured so as to be able to grasp and hold a glass sheet or marble slab.

The control unit 4 of gripping equipment 1, on the other hand, is preferably firmly fixed on the free end of the rectilinear tubular element 14.

With reference to FIGS. 3 and 4, additionally, the rectilinear tubular element 10 and preferably also the rectilinear tubular element 14 have a sectional modular structure.

In other words, the rectilinear tubular element 10, and preferably also the rectilinear tubular element 14, is basically made up of two rectilinear metallic section-bars 21 of given length and with a substantially L-shaped cross-section, separate and distinct from one another, which are arranged adjacent to one another and are shaped so as to be able to be firmly fitted one into the other along the respective longer longitudinal edges, so as to form a rigid tubular structure with polygonal cross-section that substantially copies the shape of the rectilinear tubular element 10, 14.

More in detail, each rectilinear metallic section-bar 21 is preferably provided, along its two longer longitudinal edges, with a male-female coupling system which is complementary to that of the other rectilinear metallic section-bar 21, and allows the two rectilinear metallic section bars 21 to firmly fit one into the other along the longer longitudinal edges.

With reference to FIGS. 3 and 4, in particular each of the two rectilinear metallic section bars 21 preferably has, along one of its two longer longitudinal edges, a series of preferably substantially plate-shaped, protruding teeth 22 which jut out cantilevered from the section-bar spaced side-by-side to one another, and are adapted to engage as many coupling seats 23 suitably formed on the facing longer longitudinal edge of the other rectilinear metallic section-bar 21.

Preferably, the protruding teeth 22 are furthermore spaced in a substantially regular manner along the entire length of the corresponding longer longitudinal edge of the rectilinear metallic section-bar 21, and the coupling seats 23 preferably have a shape substantially complementary to that of the corresponding protruding teeth 22.

In other words, each rectilinear metallic section-bar 21 is preferably provided with a series of protruding teeth 22 that jut out cantilevered from a first longer longitudinal edge of the section-bar, preferably spaced in a substantially regular manner along the entire length of the edge/section-bar; and with a series of coupling seats 23 that are distributed along the second longer longitudinal edge of the section-bar, each aligned with a respective protruding tooth 22.

Preferably, the coupling seats 23 present on each rectilinear metallic section-bar 21 moreover are pass-through slotted-holes or openings, and the protruding teeth 22 are dimensioned to extend in pass-through manner through said pass-through slotted-holes or openings.

Additionally, the two rectilinear metallic section-bars 21 are preferably firmly and permanently fixed to one another by means of welds along the longer longitudinal edges.

More in detail, some or all of the teeth of one or each rectilinear metallic section-bar 21 are preferably firmly fixed to the body of the other rectilinear metallic section-bar 21 by means of localised welds.

Clearly, if the rectilinear tubular elements 10 and 14 had an hexagonal cross-section, the two rectilinear metallic section-bars 21 would have a substantially C-shaped cross-section.

With reference to FIG. 4, preferably the rectilinear tubular element 10, 14 furthermore also comprises at least one longitudinal lath 24 substantially rectilinear and made of metallic material, which extends parallel to the longitudinal axis of the rectilinear tubular element 10, 14, and is placed in abutment against the rigid tubular structure with polygonal cross-section formed by the two rectilinear metallic section-bars 21, preferably inside the same rigid tubular section.

The/each longitudinal lath 24 has the function of locally increasing the overall thickness of the piece, and is preferably rigidly fixed to the rigid tubular structure with polygonal cross-section formed by the two rectilinear metallic section-bars 21 by means of welds and/or transversal anchoring-screws.

Additionally, the longitudinal lath(s) 24 have a length preferably smaller than or equal to the overall length of the rigid tubular structure with polygonal cross-section formed by the rectilinear metallic section-bars 21.

In the example shown, in particular, the rectilinear tubular element 10 is preferably provided with two longitudinal laths 24, which have a length substantially equal to the overall length of the rigid tubular structure with polygonal cross-section, and are preferably placed opposite one another, inside the rigid tubular section with polygonal cross-section formed by the two rectilinear metallic section-bars 21. Preferably, the two longitudinal laths 24 are moreover firmly fixed each to a respective rectilinear metallic section-bar 21.

Clearly, the longitudinal lath(s) 24 could also be placed outside of the rigid tubular structure with polygonal cross-section formed by the two rectilinear metallic section-bars 21.

Moreover, in a different embodiment, the longitudinal lath(s) 24 could be replaced by one or more longitudinal guide 24 preferably made of metallic material, so as to allow the sliding mounting of other components.

With reference to FIGS. 3 and 4, preferably the two rectilinear metallic section-bars 21 that concur in forming the rectilinear tubular element 10, 14 moreover have substantially the same shape.

Additionally, at least one and more conveniently each rectilinear metallic section-bar 21 is preferably made in one piece starting from a single metal plate of appropriate thickness, which is cut and bent on itself so as to form the rectilinear metallic section-bar 21.

Preferably, said metal plate is furthermore made of steel and/or has a nominal thickness ranging between 2 and 15 mm (millimetres).

In the example shown, in particular, the metal plate that forms each rectilinear metallic section-bar 21, has a nominal thickness preferably ranging between 3 and 10 mm (millimetres).

Operation of lifting apparatus 100 and of gripping equipment 1 are easily inferable from what described above and thus do not need further explanations.

The production of gripping equipment 1, on the other hand, preferably provides for assembling the rigid support framework 2 and then fixing/mounting the gripping member/s 3 onto the rigid support framework 2.

The assembly of the rigid support framework 2, in turn, provides for making, for each rectilinear tubular element 10, 14 with sectional modular structure, a pair of rectilinear metallic section-bars 21 having a substantially C- or L-shaped cross-section (see FIGS. 5, 6 and 7), and then for fitting the two rectilinear metallic section-bars 21 one into the other (see FIGS. 4 and 8), along the respective longer longitudinal edges and preferably by means of a male-female coupling system, so as to form a rigid tubular structure having a polygonal cross-section that substantially copies the shape of the rectilinear tubular element 10, 14.

Additionally, the assembly of rigid support framework 2 provides, for each rectilinear tubular element 10, 14 with sectional modular structure, also for the step of welding the two rectilinear metallic section-bars 21 to one another along the respective longer longitudinal edges.

More in detail, with reference to Figures from 5 to 8, the assembly of rigid support framework 2 preferably provides for making at least one and more conveniently both the rectilinear metallic section-bars 21 that concur in forming the/each rectilinear tubular element 10, 14, in a single piece starting from a single metal plate of appropriate thickness, which is cut and bent on itself so as to form the rectilinear metallic section-bar 21.

In other words, with reference to FIGS. 5 and 6, assuming that the rectilinear tubular elements 10 and 14 are with roughly-squared cross-section, the making of at least one and more conveniently both rectilinear metallic section-bars 21 moreover comprises the steps of:
cutting, preferably by means of a laser cutting machine, a metal plate of appropriate thickness, so as to obtain a flat blank 200 of a substantially rectangular elongated shape; and then
L-bending the/each flat bank 200 along a bending line □ which is preferably substantially parallel and optionally also coinciding with the centerline of the same bank, so as to form a respective rectilinear metallic section-bar 21 with a substantially L-shaped cross-section.

Preferably, said metal plate is further made of steel and/or has a nominal thickness ranging between 3 and 10 mm (millimetres).

Clearly, if the rectilinear tubular elements 10 and 14 had for example a hexagonal cross-section, the bending of the flat bank 200 would occur along two different bending lines □ parallel to the centerline of the bank, so as to form a rectilinear metallic section-bar 21 with a substantially C-shaped cross-section.

With reference to FIG. 8, after making the two rectilinear metallic section-bars 21, the production of the or of each rectilinear tubular element 10, 14 provides for fitting the two rectilinear metallic section bars 21 into one another, by inserting the protruding teeth 22 of each section-bar 21 inside the coupling seats 23 of the other section-bar, so as to form a rigid tubular structure with polygonal cross-section that substantially copies the shape of the rectilinear tubular element 10, 14.

After fitting the two rectilinear metallic section-bars 21 one into the other, the production of the or of each rectilinear tubular element 10, 14 preferably includes also the step of welding the two rectilinear metallic section-bars 21 to one another along the respective longer longitudinal edges.

With reference to FIG. 7, preferably before fitting the two rectilinear metallic section-bars 21 one into the other, the production of the or of each rectilinear tubular element 10, 14 preferably finally also comprises the step of fixing or anyway placing a longitudinal guide or lath 24 in abutment against at least one and more conveniently both rectilinear metallic section-bars 21.

The advantages deriving from the particular structure of the rectilinear tubular element(s) 10, 14 that concur in forming the rigid support framework 2 of gripping equipment 1, are numerous.

Firstly, the particular sectional modular structure allows making rectilinear tubular elements 10, 14 of any shape starting from a single type of metal plate, with the remarkable simplifications in the supplying and storage of the materials that this entails.

In fact, from a single type of metal plate with nominal thickness for example equal to 3 mm (millimetres), it is possible to rapidly make rectilinear tubular elements with square cross-sections of 30×30 mm, 45×45 mm, 60×60 mm, 90×90 mm.

It is finally clear that modifications and variants can be made to the gripping equipment 1 and/or to the lifting apparatus 100 described above without however departing from the scope of the present invention.

For example, instead of being fixed to the ground, the supporting column 101 can be fixed to a movable slide which is capable of moving horizontally along a rail, which is preferably firmly anchored to the ceiling. In this embodiment, therefore, the supporting column 101 extends cantilevered from the movable slide downwards, and the movable beam 102 is preferably butt fixed onto the lower end of the supporting column 101.

In a further embodiment of the lifting apparatus 100, the pneumatic cylinder 108 and the electro-pneumatic control unit 109 of the weight-balancing device 105 could be replaced by an electrically-operated linear actuator and by an electronic control unit adapted to drive the linear actuator based on the signals coming from one or more load cells capable of detecting the forces acting on the suspended load.

In other words, the lifting apparatus 100 could be an electric manipulator.

As concerns regard instead the gripping equipment 1, in a first not-shown embodiment the rigid support framework 2 could lack the two metallic transversal bars 15. In this case, the gripping members 3 could be placed at the two ends of the metallic transversal bar 12, and could consist of two magnetic gripping assemblies for metal plates, preferably, though not necessarily, as those described in U.S. Pat. No. 6,663,154.

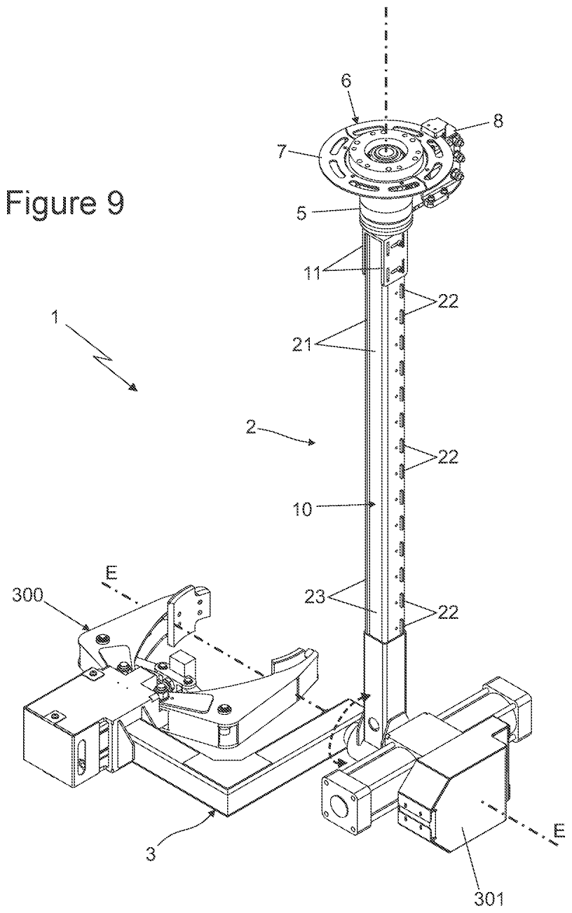

With reference to FIG. 9, in a second embodiment the gripping member 3 of gripping equipment 1 is preferably fixed directly to the lower end of the rectilinear tubular element 10 with polygonal cross-section, with sectional modular structure.

Therefore, in this embodiment, the rigid support framework 2 comprises the sole rectilinear tubular element 10.

Preferably, the gripping member 3 moreover comprises: a pneumatically-operated pliers assembly 300, which is fixed cantilevered to the lower end of the rectilinear tubular element 10, on the side of the rectilinear tubular element 10, with the capability of freely rotating about a rotation axis E preferably locally substantially perpendicular to the longitudinal axis of the rectilinear tubular element 10, and thus substantially perpendicular to axis D; and preferably also a preferably electro-pneumatically operated, rotating actuator 301 that is capable of rotating, on command, the pliers assembly 300 about the axis E.

The control unit 4 (not shown in this figure) is preferably fixed on the side of the rectilinear tubular element 10 and is preferably adapted to control the pliers assembly 300 and/or the rotating actuator 301.

Clearly, the gripping member 3 could also be a large lifting hook firmly fixed to the lower end of the rectilinear tubular element 10, or a magnetic gripping assembly as the one described in U.S. Pat. No. 6,663,154.

1. Gripping equipment (1) for lifting apparatuses (100) of the type comprising: a rigid support framework (2) which is adapted to be fixed/attached to the lifting apparatus (100); and one or more manually controlled gripping members (3) that are firmly fixed to said rigid support framework (2) and are adapted to grasp and hold a specific object to be moved;
the gripping equipment (1) being characterised in that said rigid support framework (2) comprises at least one rectilinear tubular element with polygonal cross-section (10, 14), which is made of metal and has a sectional modular structure.

2. The gripping equipment according to claim 1, wherein said at least one rectilinear tubular element with polygonal cross-section (10, 14) comprises two rectilinear metallic section-bars (21) of given length and with a substantially C- or L-shaped cross-section, separate and distinct from one another, which are firmly fitted one into the other along the respective longer longitudinal edges, so as to form a rigid tubular structure with a polygonal cross-section that substantially copies the shape of said rectilinear tubular element (10, 14).

3. The gripping equipment according to claim 2, wherein each rectilinear metallic section-bar (21) is provided, along its two longer longitudinal edges, with a male-female coupling system which is complementary to that of the other rectilinear metallic section-bar (21), and allows the two rectilinear metallic section-bars (21) to firmly fit one into the other along the same longer longitudinal edges.

4. The gripping equipment according to claim 3, wherein each rectilinear metallic section-bar (21) has, along one of its two longer longitudinal edges, a series of protruding teeth (22) that jut out cantilevered from the section-bar spaced side-by-side to one another, and are adapted to engage as many coupling seats (23) formed on the facing longer longitudinal edge of the other rectilinear metallic section-bar (21).

5. The gripping equipment according to claim 4, wherein the protruding teeth (22) are substantially plate-shaped.

6. The gripping equipment according to claim 4, wherein the protruding teeth (22) are substantially regularly spaced along the whole length of the longer longitudinal edge of the section-bar, and/or wherein the coupling seats (23) have a shape substantially complementary to that of the corresponding protruding teeth (22).

7. The gripping equipment according to claim 4, wherein the coupling seats (23) are pass-through slotted-holes or openings.

8. The gripping equipment according to claim 7, wherein the protruding teeth (22) are dimensioned so as to engage in pass-through manner said pass-through slotted-holes or openings.

9. The gripping equipment according to claim 2, wherein the two rectilinear metallic section-bars (21) are firmly fixed to one another also via welds along said longer longitudinal edges.

10. The gripping equipment according to claim 2, wherein at least one of the two rectilinear metallic section-bars (21) is made in one piece starting from a single metal plate of appropriate thickness, which is cut and bent on itself so as to form said rectilinear metallic section-bar (21).

11. The gripping equipment according to claim 10, wherein said metal plate has a nominal thickness ranging between 2 and 15 mm.

12. The gripping equipment according to claim 2, wherein said at least one rectilinear tubular element with polygonal cross-section (10, 14) additionally comprises at least one longitudinal guide or lath (24) which extends parallel to the longitudinal axis of the rectilinear tubular element with polygonal cross-section (10, 14), and is placed in abutment against the rigid tubular structure formed by said rectilinear metallic section-bars (21).

13. A construction method of the gripping equipment (1) of a lifting apparatus (100) wherein the gripping equipment (1) comprises: a rigid support framework (2) which is adapted to be fixed/attached to the lifting apparatus (100) and includes at least one rectilinear tubular element with polygonal cross-section (10, 14); and one or more manually controlled gripping members (3) that are firmly fixed on said rigid support framework (2), and are adapted to grasp and hold a specific object to be moved;
said construction method being characterised in that it comprises the steps of:
manufacturing, for said at least one rectilinear tubular element with polygonal cross-section (10, 14), a pair of rectilinear metallic section-bars (21) having a substantially C- or L-shaped cross-section; and then
fitting the two rectilinear metallic section-bars (21) one into the other, along the respective longer longitudinal edges, so as to form a rigid tubular structure having a polygonal cross-section that substantially copies the shape of said rectilinear tubular element with polygonal cross-section (10, 14).

14. The construction method of the gripping equipment of a lifting apparatus according to claim 13, wherein the two rectilinear metallic section-bars (21) fit one into the other by means of a male-female coupling system placed along the longer longitudinal edges of the section-bars.

15. The construction method of the gripping equipment of a lifting apparatus according to claim 13, characterised by additionally comprising the step of welding the two rectilinear metallic section-bars (21) to one another along the respective longer longitudinal edges.

16. The construction method of the gripping equipment of a lifting apparatus according to claim 13, wherein the manufacturing of at least one of said rectilinear metallic section-bars (21) comprises the steps of:
cutting a metal plate of appropriate thickness, so as to obtain a flat blank (200) having a substantially elongated rectangular shape; and then
L-bending the flat blank (200) along at least one predetermined bending line, so as to form said rectilinear metallic section-bar (21).

17. The construction method of the gripping equipment of a lifting apparatus according to claim 13, characterised by additionally comprising the step of fixing a longitudinal guide or lath (24) onto at least one of said rectilinear metallic section-bars (21).

18. A manually-operated lifting apparatus (100) comprising: a supporting column (101); a movable beam (102) which is butt fixed to the supporting column (101) with the capability of swinging over a substantially horizontal plane; and a movable arm (103) that extends in cantilever manner from the distal end of the movable beam (102), and is butt fixed to the distal end of the movable beam (102) with the capability of freely rotating with respect to the latter about a first, substantially horizontal, rotation axis (B), so as to be able to swing over a second substantially vertical plane;
the lifting apparatus (100) being characterised by additionally comprising a gripping equipment (1) which is realized according to claim 1, and is fixed/coupled to the distal end of the movable arm (103) so as to be directly supported by said movable arm (103).

19. The lifting apparatus according to claim 18, wherein said movable arm (103) is moreover fixed to the distal end of the movable beam (102) also with the capability of freely rotating with respect to the latter about a second, substantially vertical, rotation axis (C), so as to be able to swing also over a third substantially horizontal plane.

20. The lifting apparatus according to claim 18, characterised by additionally comprising a weight-balancing device (105) which is adapted to continuously compensate the weight of the movable arm (103), of the gripping equipment (1) and of the object that is temporarily integral therewith.
